(19) United States
(12) Patent Application Publication
(10) Pub. No.: US 2006/0104632 A1
(43) Pub. Date: May 18, 2006

(54) Supporting and protecting device for lens

(76) Inventor: Chan-Min Ma, Taipei City (TW)

Correspondence Address: LADAS & PARRY, 26 WEST 61ST STREET, NEW YORK, NY, 10023, US

(21) Appl. No.: 11/195,131

(22) Filed: Aug. 2, 2005

Related U.S. Application Data
(63) Continuation-in-part of application No. 10/988,237, filed on Nov. 12, 2004, now abandoned.

(51) Int. Cl. G03B 17/00

(52) U.S. Cl. 396/419

(57) ABSTRACT

This invention relates to a supporting and protecting device for lens, comprising a ring collar and at least one cushion. The ring collar is adapted to be fastened to the leading edge of a lens, and at least one cushion is disposed at a bottom area of the ring collar, respectively. When the lens is placed over a plane, at least one cushion is arranged to support the ring collar and the lens above the plane.

### BACKGROUND OF THE INVENTION

1. Field of the Invention

The invention relates to a supporting and protecting device for lens, especially to a supporting device that prevents colliding or rolling of lens. This is a continuation-in-part of patent application Ser. No. 10/988,237, filed on 12 Nov. 2004.

2. Description of the Related Art

FIG. 1 is a schematic view of a long-lens single lens reflex or a pro-sumer camera 20 placed over a plane. Because the lens 21 is long and the centre of gravity of the camera 20 is moved forward, one end of the lens 21 of the camera 20 directly contacts the plane. For a common professional photographer, the lens of a camera is a very precise and expensive instrument, which must be handled carefully. Thus, when laying a camera, it must be laid flat carefully by hands first, and then its lens is placed gently over the plane. However, this way of placing may still result in the lower part of the front end of the lens 21 leaning forward if the camera is carelessly placed, and therefore the lower part of the front end of the lens 21 may be damaged by impact. In addition, for a detachable lens, it is not easy to place it over a plane stably due to its cylindrical shape. When the lens is placed transversely on a tabletop alone, it is very possible that the lens may roll down to the ground due to the rather uneven surface or careless contact by others, resulting in serious damage. Similarly, for a pro-sumer camera with a permanently mounted lens, since it is generally more expensive than a standard camera for an amateur user, the same problem may arise when the lens is placed in an inappropriate way, which in turn, results in damage of the lens and considerable loss to the user.

From the above, it is necessary for the industry to provide a supporting and protecting device which can prevent the possibility of the lens being damaged.

### SUMMARY OF THE INVENTION

It is an object of this invention to provide a supporting and protecting device for lens so that the lens can be placed over a plane stably, thereby preventing damage resulting from the collision of the lens with another object. According to this invention, the supporting and protecting device for lens comprises a ring collar and at least one cushion. The ring collar, which may be a cover, is adapted to be fastened to the leading edge of a lens, and at least one cushion is disposed at a bottom of the ring collar for supporting the ring collar and the lens above a plane when the lens is placed over the plane. Alternatively, the device can have two cushions disposed at opposite sides of a bottom thereof, respectively. When the lens is placed over a plane, the two cushions are adapted to support the ring collar and the lens above the plane.

This and other objects and advantages of the present invention will become apparent to those skilled in the art from the following detailed description of the invention and the accompanying drawings. However, the description is only to describe the preferred embodiments of the invention, not to limit the invention in any form. Any modification or changes in the same spirit of the invention should be within the scope of protection for this invention.

### DESCRIPTIONS OF THE DRAWINGS

FIG. 1 is a schematic view showing a single lens reflex or a pro-sumer camera placed over a plane;

FIG. 2 is a schematic view showing the supporting and protecting device for lens with one cushion, separated from the camera according to the present invention;

FIG. 3 is a schematic view thereof showing the supporting and protecting device for lens fastened to the camera;

FIG. 4 is a cross-sectional view thereof showing a solid cushion;

FIG. 5 is a cross-sectional view thereof showing a hollow cushion;

FIG. 6 is a cross-sectional view thereof showing an alternative form of the cushion;

FIG. 7 is a schematic view showing an alternative supporting and protecting device for lens with two cushions separated from a camera according to the present invention;

FIG. 8 is a schematic view thereof showing the supporting and protecting device for lens fastened to the camera;

FIG. 9 is a cross-sectional view thereof showing two solid cushions;

FIG. 10 is a cross-sectional view thereof showing two hollow cushions; and

FIG. 11 is a cross-sectional view thereof showing an alternative form of the cushions.

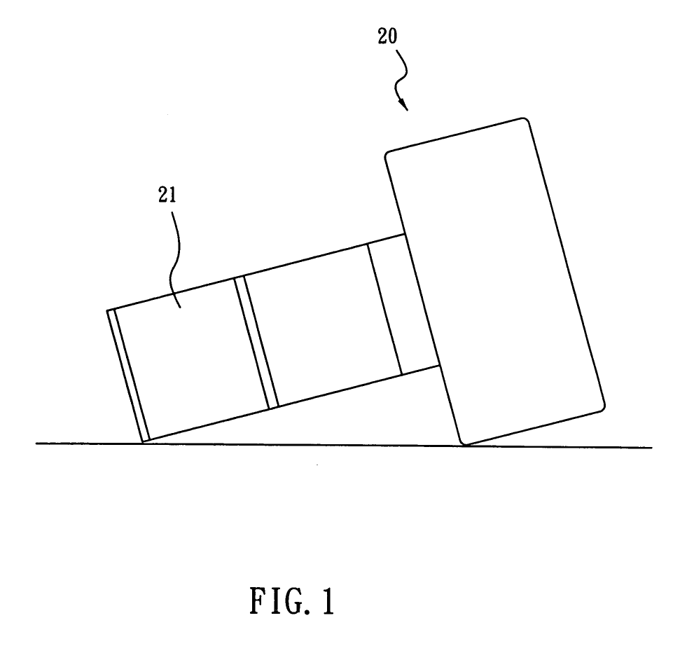

### DETAILED DESCRIPTION OF THE INVENTION

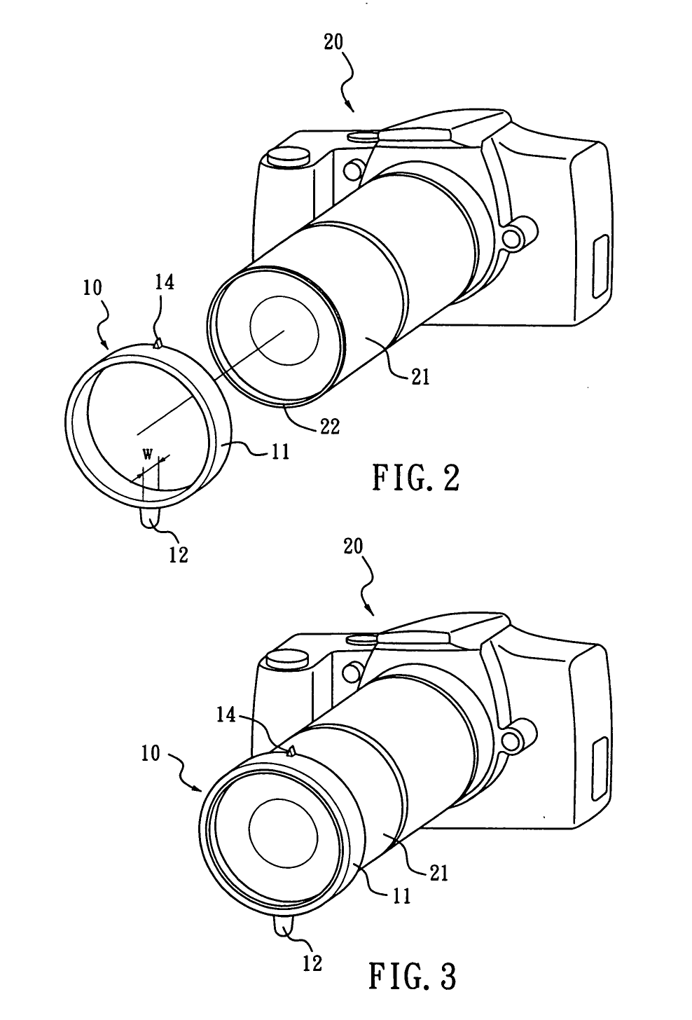

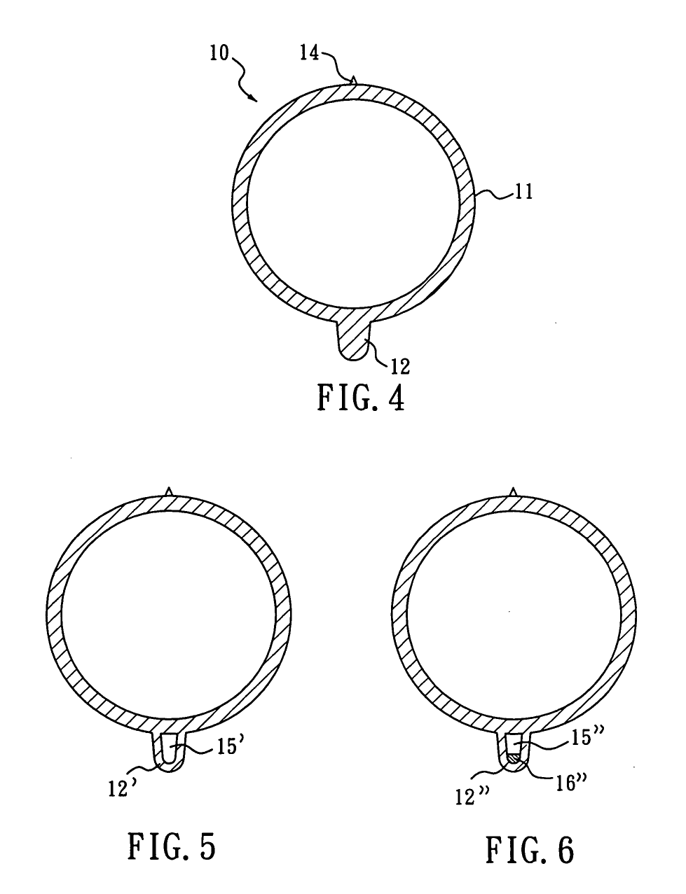

As illustrated in FIGS. 2 and 4, the supporting and protecting device 10 for lens comprises a ring collar 11 and a cushion 12. The cushion 12 can be integrated with the ring collar 11, or can be made by other appropriate manufacturing methods. As shown in FIG. 3, the ring collar 11, which can be a cover (not shown in figures) and has a width w (see FIG. 2), is adapted to be fastened to the leading edge 22 of a lens 21 of a camera 20, preferably a pro-sumer type, and serves to cover the lens 21 when the ring collar 11 is used as a cover. A cushion 12 disposed at a bottom of the ring collar 11 is adapted to support the ring collar 11 and the lens 21 above a plane when the lens 21 is placed over the plane so as to prevent any possible damage due to the collision of the lens 21 with another object if placed improperly. Additionally, the supporting and protecting device 10 for lens generally may have three different dimensions, namely large, middle and small, for different dimensions and diameters of lenses so as to cater to different types of cameras or photographic equipment. The device 10 can also be made of an elastic material to fit lenses with different diameters.

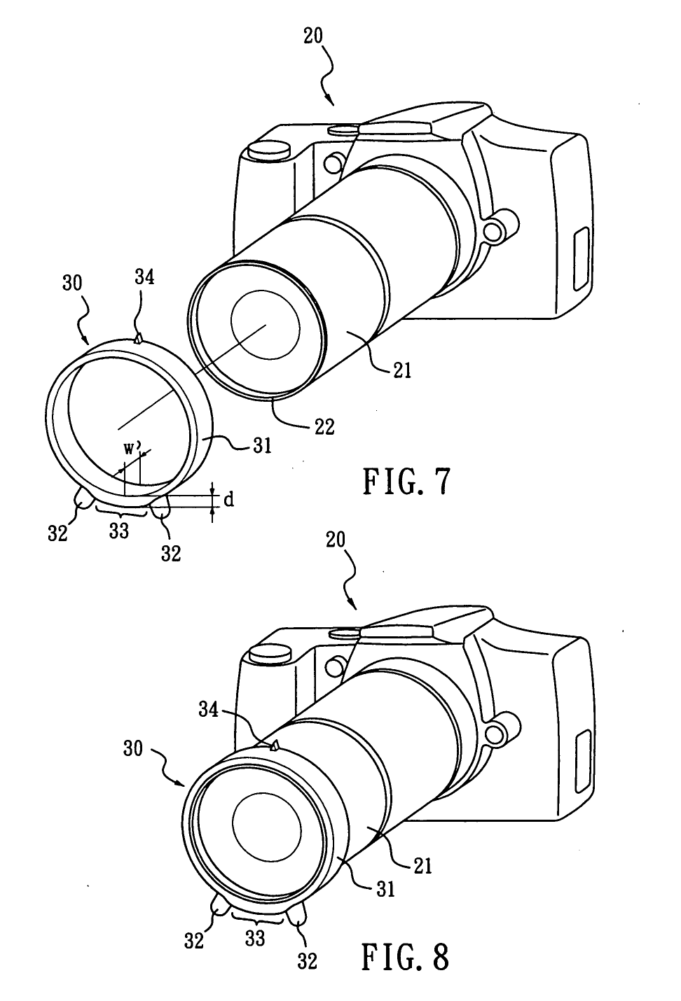

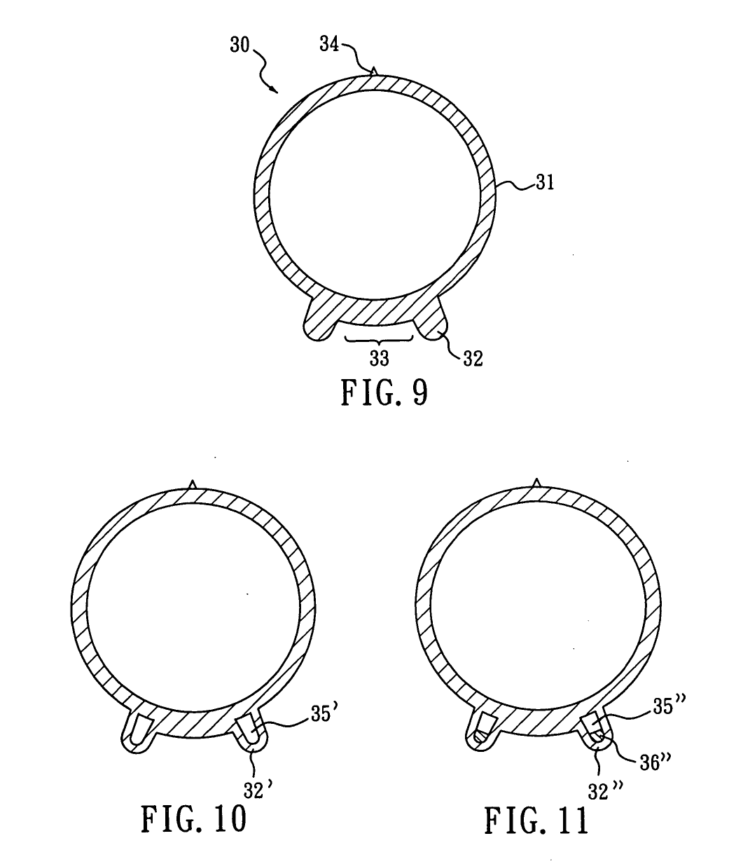

FIGS. 7 to 9 are schematic views showing how to use an alternative supporting and protecting device for lens according to the present invention and a cross-sectional view thereof, respectively. As illustrated in FIGS. 7 and 9, the supporting and protecting device 30 for lens has a similar configuration to the supporting and protecting device 10 for lens as described in the previous paragraph and is equipped with two cushions 32. As shown in FIG. 8, a ring collar 31 is adapted to be fastened to the leading edge 22 of a lens 21 of a camera 20 and has a width w′ (see FIG. 7). The two cushions 32 are disposed at the left and right sides of the bottom of the ring collar, 31 which defines a bottom area 33 of the ring collar 31. When the lens 21 is placed over a plane, the two cushions 32 are adapted to simultaneously support the ring collar 31 and the lens 21 above the plane. Similarly, the supporting and protecting device 30 for lens generally may have three different dimensions and can also be made of an elastic material to fit lenses with different diameters. Furthermore, the ring collar 31 may also be put on after the lens 21 is detached from the camera 20 to prevent the lens 21 from rolling on the plane.

Referring to FIG. 7, the thickness d of the bottom area 33 of the ring collar 31 between the two cushions 32 is designed to be greater than the thickness of the other areas of the ring collar 31 (e.g., twice the size) in order to prevent the ring collar 31 from expanding towards the left and right sides due to tension while being put on the lens 21, thus avoiding the instability of the supporting and protecting device 30 for lens due to protrusion of the bottom area 33 between the two cushions 32 as a result of transverse separation of the two cushions 32. The thickness of the bottom area 33 should be no larger than the height supported by the two cushions 32 to ensure that the two cushions 32 can contact the plane and support the ring collar 31 and the lens 21 stably. In addition, a jut 14, 34 can be disposed at the centre on the top of the ring collar 11, 31 (referring to FIGS. 2 and 7), which serves as an indicator to accurately position the supporting and protecting device 10, 30 for lens relative to the lens 21.

Referring to FIGS. 4 to 6 and 9 to 11, apart from the one or two solid cushions 12, 32 shown in FIG. 4 or 9, a hollow area 15′, 35′ can be formed inside the cushion 12′ or each of the two cushions 32′ as shown in FIG. 5 or 10. In addition, as shown in FIG. 6 or 11, a hollow area 15″, 35″ can be formed in the upper part inside the cushion 12″ or each of the two cushions 32″ with a metal block 16″, 36″ embedded in each of the lower parts thereof to achieve a better cushioning effect. Each of the cushion 12, 32 may also be designed as conical, spherical or another finger-like protrusion according to different requirements.

As shown above, the invention provides a supporting and protecting device for lens with a simple structure, which is easy to produce and use with high stability. Not only can it cater to lenses of different cameras, such as a professional single lens reflex camera or a pro-sumer camera, but it can also be used for lenses of different photographic equipment, so that the lens may be safely positioned on a plane alone, avoiding the damage resulting from a collision and protecting the valuable fittings of the photographer. While the invention has been described in terms of several preferred embodiments, those skilled in the art will recognise that the invention can still be practiced with modifications, within the spirit and scope of the appended claims.

What is claimed is:

1. A supporting and protecting device for lens, comprising:
a ring collar for fastening to a leading edge of a lens and having a width; and
at least one cushion disposed at a bottom of the ring collar for supporting the ring collar and the lens above a plane when the lens is placed over the plane.

2. The supporting and protecting device for lens according to claim 1, wherein the ring collar is a cover for covering the lens.

3. The supporting and protecting device for lens according to claim 1, wherein
the device has two cushions disposed at opposite sides and defining a bottom area thereof between the two cushions such that when the lens is placed over a plane, the two cushions simultaneously support the ring collar and the lens above the plane.

4. The supporting and protecting device for lens according to claim 1, wherein the supporting and protecting device for lens is made of an elastic material.

5. The supporting and protecting device for lens according to claim 1, wherein the ring collar is integrated with the cushion.

6. The supporting and protecting device for lens according to claim 3, wherein the thickness of the bottom area of the ring collar between the two cushions is greater than that of the other areas of the ring collar.

7. The supporting and protecting device for lens according to claim 6, wherein the thickness of the bottom area between the two cushions is twice that of the other areas of the ring collar.

8. The supporting and protecting device for lens according to claim 1, wherein a jut is disposed at the centre on the top of the ring collar.

9. The supporting and protecting device for lens according to claim 1, wherein the cushion is hollow.

10. The supporting and protecting device for lens according to claim 9, wherein the cushion is formed therein with an upper part and a lower part and the lower part is provided with a metal block while the upper part is hollow.

11. The supporting and protecting device for lens according to claim 1, wherein the cushion is conical.

12. The supporting and protecting device for lens according to claim 1, wherein the cushion is spherical.

13. The supporting and protecting device for lens according to claim 1, wherein the cushion is a finger-like protrusion.
